(19) United States
(12) Patent Application Publication
(10) Pub. No.: US 2010/0235266 A1
(43) Pub. Date: Sep. 16, 2010

(54) Determining Charge for Content Distribution

(75) Inventors: Sarah Sirajuddin, Sunnyvale, CA (US); Dimitre R. Trendafilov, Redwood City, CA (US); Oren E. Zamir, Los Altos, CA (US); Aitan Weinberg, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/401,457

(22) Filed: Mar. 10, 2009

(51) Int. Cl. G06Q 10/00; G06Q 30/00; G06Q 50/00

(52) U.S. Cl. 705/30; 705/400

(57) ABSTRACT

A method of determining charge for content presentation includes identifying multiple target criteria that a content provider specifies for distribution of content, the multiple target criteria associated in a hierarchy. The method includes determining, for a presentation of the content to a user, which of the multiple target criteria are met by the presentation. The method includes recording a charge to the content provider for the presentation, the charge determined using the hierarchy and charge values associated with the multiple target criteria. The method can be implemented using a computer program product tangibly embodied in a computer-readable storage medium and comprising instructions that when executed by a processor perform the method.

### TECHNICAL FIELD

This document relates to information processing.

### BACKGROUND

Content is distributed in computer systems or by other technologies in different situations. For example, advertisements can be used in an attempt to inform people about a wide variety of products, goods, and services. Generally, advertisers may seek to target the content of their advertising to the intended audience or viewers.

Advertisements can take many forms, such as printed material, commercials on television and radio, and billboards. These advertisements can be placed without detailed knowledge about the potential viewers for the purpose of reaching potential customers who encounter the advertisement coincidentally. Advertisements are sometimes placed to target a particular demographic group (e.g., ads for toys in a TV show for children or billboards for tires along a roadside) in order to increase the chances of reaching potential customers.

### SUMMARY

In a first aspect, a method of determining charge for content presentation includes identifying multiple target criteria that a content provider specifies for distribution of content, the multiple target criteria associated in a hierarchy. The method includes determining, for a presentation of the content to a user, which of the multiple target criteria are met by the presentation. The method includes recording a charge to the content provider for the presentation, the charge determined using the hierarchy and charge values associated with the multiple target criteria. The method can be implemented using a computer program product tangibly embodied in a computer-readable storage medium and comprising instructions that when executed by a processor perform the method.

Implementations can include any or all of the following features. The method can further include determining, before the content is presented, whether a publisher that is to publish the content in the content distribution has opted out of user-targeted content distribution. The multiple target criteria can include at least: a first target criterion that the content be presented to a user associated with at least one of a collection of user identifiers; a second target criterion that the content be presented in a predetermined resource; and a third target criterion that the content be presented in association with a predetermined keyword. At least two of the multiple target criteria can be met by the presentation, and the method can further include selecting one of the at least two target criteria and using the one target criterion in determining the charge. The multiple target criteria can be ranked according to specificity in the hierarchy, and the one target criterion can be selected as being most specific of the at least two target criteria met by the presentation. Another collection of user identities can be identified by the content provider, and the other collection of user identities can also be taken into account in the determination. The method can further include forming a logical combination collection based on the collection of user identities and the other collection of user identities, wherein the logical combination collection is taken into account in the determination. The method can further include performing an evaluation of a duration or expiration measure for the collection of user identities, wherein the evaluation is taken into account in the determination. The content provider may have submitted a bid for the content distribution comprising at least two different bid amounts, the charge values are based on the different bid amounts, and at least one of the different bid amounts can be conditioned on the determination that the user is associated with one of the user identities. The multiple target criteria can include at least one selected from the group consisting of: a user action; a user access of a specific resource; a demographic criterion; a keyword for matching against a publication where the content distribution is made; an identifier for the publication where the content distribution is made; a language of the publication where the content distribution is made; a geographic location of the user; a time of day when the content distribution is made; a location in the publication where the content distribution is made; a metric regarding the publication where the content distribution is made; a maximum number of presentations associated with the content.

A graphical user interface for defining user-specific content presentation includes at least one criterion input control for a content provider to specify multiple target criteria associated in a hierarchy, the multiple target criteria configured for use in selecting between a plurality of users for receiving a content distribution. The graphical user interface includes a charge input control for the content provider to define respective charge values associated with the multiple target criteria, wherein a charge to the content provider is recorded for a presentation of the content to a user, the charge determined using the hierarchy and the charge value associated with any of the multiple target criteria met by the presentation. The graphical user interface can be implemented using a computer program product tangibly embodied in a computer-readable storage medium, the computer program product including instructions that, when executed, generate the graphical user interface on a display device.

Implementations can include any or all of the following features. The criterion input control can be configured for use by the content provider in uploading a collection of user identities. The criterion input control can be configured so that the content provider can offer the collection of user identities for use by another content provider. The multiple target criteria can include at least: a first target criterion that the content be presented to a user associated with at least one of a collection of user identifiers; a second target criterion that the content be presented in a predetermined resource; and a third target criterion that the content be presented in association with a predetermined keyword. At least two of the multiple target criteria can be met by the presentation, and one of the at least two target criteria can be selected and used in determining the charge. The multiple target criteria can be ranked according to specificity in the hierarchy, and the one target criterion can be selected as being most specific of the at least two target criteria met by the presentation. The graphical user interface can further include a performance reporting area presenting a result of the content distribution to the content provider. The performance reporting area can divide the result in at least first and second result categories: the first result category corresponding to a portion of the content distribution performed to at least a first user who is not associated with a collection of user identities specified by the content provider as one of the multiple target criteria; and the second category corresponding to a portion of the content distribution performed to at least a second user who is associated with one of the user identities.

Implementations can provide any, all or none of the following advantages. Content distribution can be improved. A content provider can provide a list of identifiers and cause content to be distributed to any user on the list provided a criterion is met. A content provider can use a hierarchy of criteria to define a content distribution, and a compensation for the distribution can be based on how many criteria are met and/or on a hierarchy of the criteria.

The details of one or more implementations are set forth in the accompanying drawings and the description below. Other features and advantages will be apparent from the description and drawings, and from the claims.

### DESCRIPTION OF DRAWINGS

FIG. 1 shows an example system that can be used for content distribution.

FIG. 2 shows an example graphical user interface for defining user-specific content presentation.

FIG. 3 shows an example graphical user interface for presenting results of a content distribution.

FIG. 4 is a flow chart showing an example procedure for content distribution.

FIG. 5 is a flow chart showing an example procedure for defining user-specific content presentation.

FIG. 6 is a flow chart showing an example procedure for determining charge for content presentation.

FIG. 7 is a block diagram of a computing system that can be used in connection with computer-implemented methods described in this document.

Like reference symbols in the various drawings indicate like elements.

### DETAILED DESCRIPTION

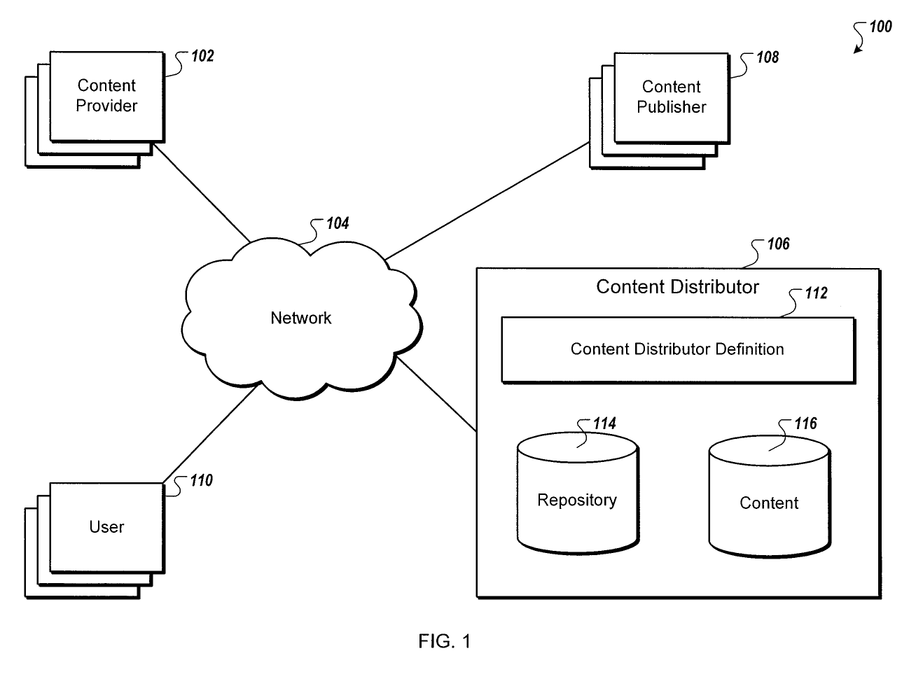

FIG. 1 shows an example system 100 that can be used for content distribution. A content provider system 102 can provide content over any kind of network 104. For example, a content provider can be an advertiser who wishes to present advertisements to one or more potential customers in an online environment, such as on a website or in an online forum. A content distributor system 106 can communicate with the content provider system 102 over the network 104. For example, an advertiser can provide an advertisement, such as multimedia or text, and/or other content to an advertisement distributor. In some implementations, the content distributor system 106 can distribute content to users over the network 104 based on a collection of user identifiers, such as a user list. For example, the content provider system can specify a hierarchy of target criteria for distributing content to user(s), and a charge to the content provider can be determined using the hierarchy, for example by determining whether the content was distributed to a user on a predefined list.

The content distributor system 106 can communicate over the network 104 with a content publisher system 108. For example, the content publisher system 108 can publish a webpage or other content that presents advertisements or other distributed content, optionally along with other content. The content publisher system 108 can publish a forum, an email service, or a massively multiplayer online game, to name just a few more examples.

Content can be provided by the content publisher system 108 to a user system 110 over the network 104. For example a user can browse content and/or advertisements provided by the content publisher system 108 on a website. The content distributor system 106 can specify if a user is to be provided with content. For example, an advertisement may be presented to a user visiting a particular website if the user and/or the website meets a condition defined in the content distributor system 106. Content can be provided to users based on one or more criteria. For example, user membership in a particular user list can be combined, such as by using a logical AND or OR operator, with one or more other criteria such as whether the user has visited a particular site and/or whether the user has viewed a page relating to football.

Content, such as advertisements, can be targeted to a user system 110. For example, in a targeted advertising system, a user system 110 searches for a keyword or keywords, and the content distributor system 106 provides advertisements to be displayed on a content publisher's website 108 that is relevant to those particular keywords. The content publisher system 108 can opt out of presenting content targeted to a specific user. In some implementations, the content provider system 102 may have or seek a list of users. Moreover, a method for distributing content to a user system 110 can be based on a collection of user identifiers, such as a user list. In some implementations, a list of users can include user names, internet protocol (IP) addresses, cookies and/or other data for identifying users, to name a few examples. The content provider system 102 can provide a list of users to the content distributor system 106. The content provider system 102 may wish to target advertisements to additional users, or a subset of users based on other dimensions, such as user or website demographics, to name two examples. The content provider system 102 may be willing to pay different amounts of compensation for content distribution to users targeted for a particular dimension. For example, an advertiser may wish to pay more for an advertisement to a 20-29 year old male than other demographic groups. In another example, an advertiser may wish to advertise a product to a user who backed out of an online purchase during a checkout process.

The content distributor system 106 can include a content distributor definition component 112. In some implementations, the content distributor definition component 112 can include a software, hardware and/or firmware module that provides controls for defining users, demographics, advertisements, compensation amounts, and/or other controls, to name just a few examples.

The content distributor system 106 can include a repository 114 of information. In some implementations, the repository 114 stores information about users, such as collections of user identities, demographics, preferences, and/or other information about users and user activity, to name a few examples.

The content distributor system 106 can include a content database 116. For example, the content database 116 can contain content such as advertisements that are configured for distribution to one or more users.

In an example scenario, the content provider system 102 may wish to target an advertisement or other content distribution to users on a list, but only if a certain keyword occurs in relation to the distribution, for example, because the keyword occurs on the page or other resource where the content is to be published. The content provider can define in a user interface generated by the content distributor definition component 112 that they wish to advertise to users on a list who meet a certain criteria and other users not specified in the list that meet the same criteria. The user information can be contained and/or stored in the repository 114. The content provider system 102 can upload an advertisement or choose an advertisement which is stored in the content database 116. The content distributor system 106 determines if the user system 110 is to receive the advertisement when the user visits a website provided by the content publisher system 108.

In some implementations, to protect the privacy of users, the content distributor system 106 and/or another component in the system 100 anonymizes data for users so that the stored data cannot be associated with the users. For example, user queries can be associated with a unique 128-bit number that is not associated with any user. Opt-in and/or opt-out procedures can be provided, and if the user opts-in for tracking of user history data and/or collection of other personal information, the system 100 can associate search queries, clicks and/or other user activities with a user identifier that is uniquely associated with the user. A user can grant permission to the content distributor system 106 to track the user's history so that historical data for the user's search sessions and other user data are tracked and associated with the user identifier. For example, at the user's option, a search engine can be configured to track only data approved by the user, such as only search queries and search result selections. The user can clear historical data associated with the user at any time, and can opt-out of such tracking at any time.

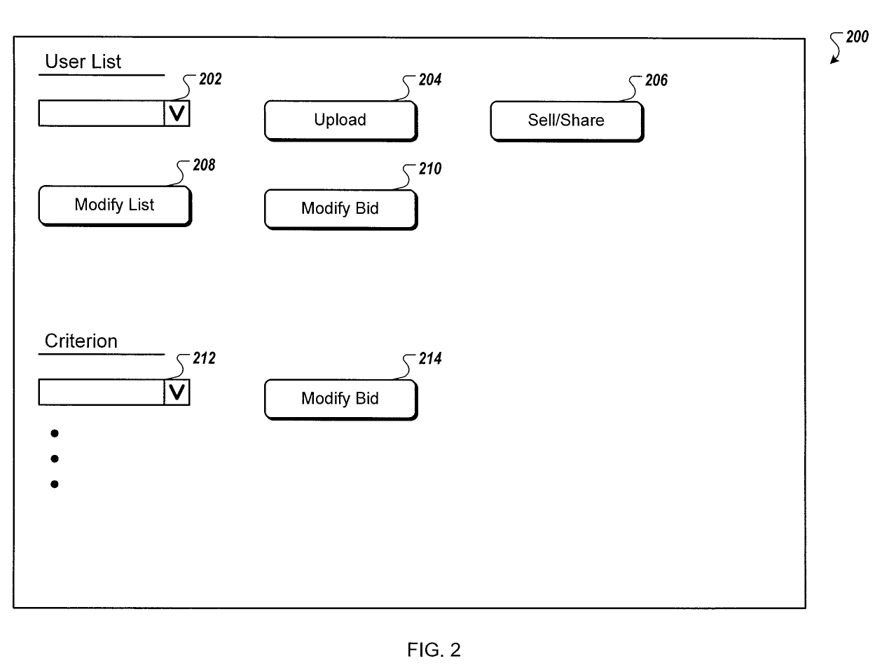

FIG. 2 shows an example graphical user interface 200 that can be used for defining user-specific content presentations. For example, the graphical user interface 200 can be presented in a web browser and can contain controls for various functions of the content distributor system 106, and can allow advertiser or other content providers to modify parameters within the content distributor definition component 112. In some implementations, the graphical user interface 200 includes a user list section and/or a criterion section with controls. For example, an advertiser can access the graphical user interface 200, such as by using the content provider system 102 to communicate with the content distributor system 106.

The graphical user interface 200 can include a user collection control 202. In some implementations, the user collection control includes a drop down menu. The user collection control 202 can contain one or more predefined collections of user identifiers. Collections of user identifiers can include lists of users, or other identifying information such as a cookie or IP address, to name a few examples. For example, an advertiser or other content provider can choose a particular predefined user list for a content distribution campaign by clicking on the user collection control 202. In some implementations, user lists for the user collection control 202 can be stored in the repository 114.

The graphical user interface 200 can include a control for uploading one or more user collections, such as an upload button 204. In some implementations, an advertiser can click on the upload button 204 to initiate uploading of a collection of user identifiers. For example, another view can be presented that allows the content provider to specify a name and/or a resource address for the collection to be uploaded. The collection of user identifiers can be stored in the repository 114 on the content distributor system 106. In some implementations, an uploaded collection of user identifiers can be presented as an option in the drop down menu 202.

The graphical user interface 200 can include a sell/share control, such as a sell/share button 206. In some implementations, an advertiser can click on the sell/share button 206 to either sell or share one or more collections of user lists with other advertisers or content distributors. For example, an advertiser may have a user list desirable to other advertisers, and can either sell or share that user list. In some implementations, a content provider may be presented with other options upon clicking the sell/share button, such as an option to set a price for one or more user lists, or to specify other content providers that can access the list or lists, to name just two examples.

The graphical user interface 200 can include a modify control, such as a modify list button 208. An advertiser can click on the modify list button 208 to modify contents of a collection of user identities. In some implementations, an advertiser may be presented with other options upon clicking the modify list button, such as an option to add users, delete users, create logical combinations of user lists, or modify other list content (e.g., IP addresses and/or other associated information) to name just a few examples. A logical combination can include Boolean operators, for example “List A AND List B,” or “NOT List C.” In some implementations, an advertiser can set a membership duration or expiration date and/or time for list content or the list itself.

The graphical user interface 200 can include a modify bid control, such as a modify bid button 210. A content provider can click on the modify bid button 210 to modify a bid amount for distributing content such as advertisements. For example, an advertiser may be willing to pay a different amount to advertise to members of one user list and can modify a bid accordingly. The modify bid button 210 can allow the advertiser to specify individual bid amounts for any of multiple targeting criteria. For example, the advertiser can specify: a first bid amount for ads presented in connection with particular keywords entered in a search engine; a second bid amount for ads presented on a particular site or other resource; and a third bid amount for ads presented to any user on a specific list. Other example criteria can include, but are not limited to, user demographics, geographic location, language, part of day, and placement within a particular resource, such as above the fold in a newspaper. In some implementations, the advertiser can specify a hierarchy of defined criteria, such as by ranking them from top to bottom. For example, when charges to the advertiser are calculated for the ad presentation, the highest ranked criterion that is met by the presentation can determine which of the advertiser's bid amounts id to be applied. In some implementations, an advertiser may be presented with other options upon clicking the modify bid button 210, such as an option to set a bid amount, a start/stop date and/or time for a bid for a user list, to name just a few examples.

The graphical user interface 200 can include a criterion control 212. In some implementations, the criterion control 212 is a drop down menu. The criterion control 212 can contain one or more predefined criteria. An advertiser can click on the criterion control 212 to choose a criterion. Predefined options in the criterion control 212 can include any of multiple criteria. For example, the control 212 can recite a user action, a user access of a specific resource, a demographic criterion, a keyword for matching against a publication where the content distribution is made, an identifier for the publication where the content distribution is made, a language of the publication where the content distribution is made, a geographic location of the user, a time of day when the content distribution is made, a location in the publication where the content distribution is made, a metric regarding the publication where the content distribution is made, and/or a maximum number of presentations associated with the content, to name just a few examples of criteria. In some implementations, the criterion control 212 or another part of the graphical user interface 200 can include an option to create customized criterion.

The graphical user interface 200 can include an additional modify bid control that is associated with the criterion control 212, such as a modify bid button 214. An advertiser can click on the modify bid button 214 to modify a bid for a content distribution. In some implementations, the modify bid button 214 can have a similar or identical function to the modify bid button 210. For example, an advertiser may want to pay a different amount to advertise to users who meet a certain criterion. In some implementations, an advertiser may be presented with other options upon clicking the modify bid button, such as specifying a value or values for the selected criterion, a bid amount, a start/stop date and/or time for a bid, or a budget, to name just a few examples. In some implementations, an advertiser can choose if they want to pay per click, per impression, and/or per conversion (e.g., a user purchasing an item from an advertiser), and can specify a preferred or maximum bid amount. In some implementations, the content distributor 106 can set the bid parameters to maximize return on investment.

In some implementations, the graphical user interface can contain multiple criterion controls 212 and/or modify bid buttons 214. For example, an advertiser may wish to select different bid amounts for different criteria. In some implementations, multiple criteria can be selected within the same drop down list. In some implementations, a bid amount can be placed for a logical combination of at least one criterion. For example, an advertiser may be willing to pay 10 cents for content presented on a webpage about football, but, if the user accessing that webpage is also on a list, the advertiser may be willing to pay 50 cents. In another example, an advertiser may specify different bid amounts for logical combinations of user list(s) and/or criterion/criteria.

A criterion associated with the criterion control 212 can correspond to data tracked by a content distributor system 106. In some implementations, an advertiser may select a criterion and specify one or more values or a range of values associated with the criterion selected. For example, for an age demographic criterion, an advertiser can select specific ages and/or a range of ages (e.g., 18-25 or 25-35). Separate bids can be placed for separate selected values, such as for the age ranges in the above example. In some implementations, criterion can be combined and a single bid can be placed for multiple criterion or combinations of criterion.

A criterion can be mandatory. For example, an advertiser can specify to only present the advertisement if the user is male. In some implementations, an additional criterion can be either mandatory or optional. Multiple criteria can be part of a hierarchy. For example, one criterion could be given higher priority than another criterion.

In an example scenario, an advertiser has a user collection, and wishes to target users who live in Minnesota, and are between 25 and 35 years old. Furthermore, the advertiser may be willing to pay more to target users who are visiting or who have visited websites relating to winter sports. The advertiser can select the appropriate criteria for age and location, place a bid, and enter any necessary additional information. To target users who are visiting or have previously visited winter sports websites, the advertiser can select a criterion specifying keywords found in a website (e.g., snow, skiing), and an amount they are willing to bid for the additional criteria.

When content is distributed, such as in the presentation of an ad, it can be determined which of multiple criteria is met by the presentation. In some implementations, a hierarchy of target criteria can be defined from the most specific (e.g., that the user is an individual identified on a predetermined list), to less specific (e.g., that the ad is presented on a particular resource, to the least specific (e.g., that the ad is displayed in connection with a particular keyword.) The charge to the advertiser can then be determined using the hierarchy. For example, if an ad presentation matches a keyword criterion and a placement criterion but not a user list criterion, the bid value for the placement criterion can be used as being more specific. As another example, if an ad presentation matches a keyword criterion and a user list criterion but not a placement criterion, the bid value for the user list criterion can be used as being more specific. As another example, if an ad presentation matches a placement criterion and a user list criterion but not a keyword criterion, the bid value for the user list criterion can be used as being more specific. Other approaches for charge determination can be used.

In some implementations, the methods and techniques described herein can allow an advertiser to refine the audience for an ad based on multiple criteria. For example, the advertiser can have a user list for “in-market vacation buyers” and wants to shown an ad to these users only when they are visiting vacation or vacation related pages and not when they are reading news. In some implementations, the advertiser can define “related” pages by either picking the sites or the keywords. Another example involves an advertiser with ad campaign that is targeting keywords, say “cars”. Moreover, the advertiser may have entered a bid to pay $2 per click. The advertiser can change the campaign to target to a user list of “in-market car buyers” ($5 per click) in addition to the advertiser's existing keywords. For example, if a user on the selected user list clicks on the ad, the advertiser is charged $5, else the advertiser is charged $2.

In some implementations, advertisers can bid to pay by either impression (cost per thousand, or CPM), by click (cost per click, or CPC) or conversions (CPA). The advertisers can pick what metric they care about more. The latter two will involve us training our smartass models such that we can come up with predicted likelihood of clicks/conversions on ad when it is participating in the auction.

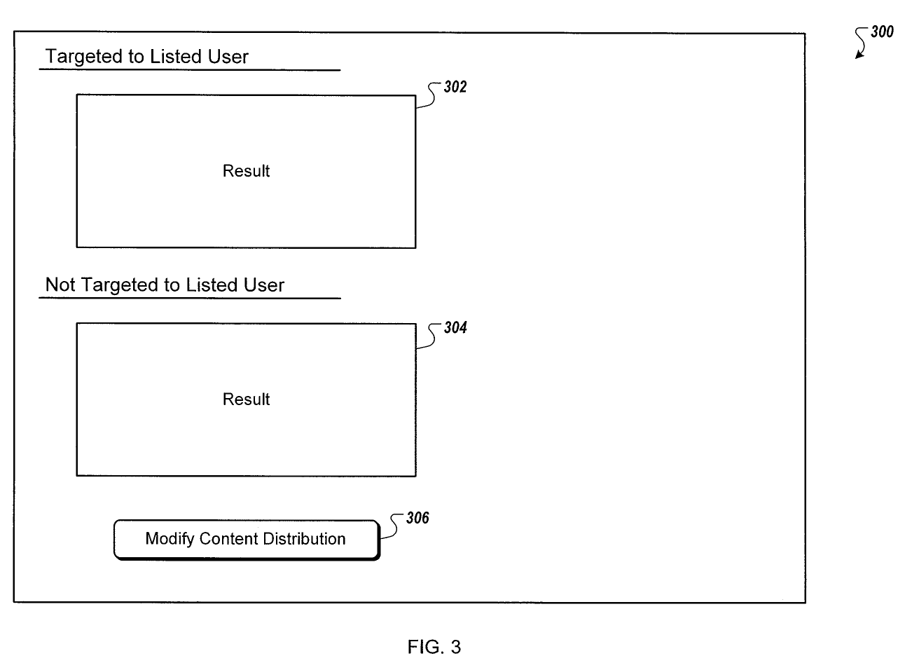

FIG. 3 shows an example graphical user interface 300 that can be used for presenting results of a content distribution. For example, the graphical user interface 300 can be presented in a web browser and include one or more reporting features that inform a content provider such as an advertiser about an outcome of a content distribution. As another example, the graphical user interface 300 can contain controls for various functions of the content distributor system 106, and/or can allow advertisers to modify parameters within the content distributor definition component 112. In some implementations, the graphical user interface 300 includes multiple results categories. For example, an advertiser can access the graphical user interface 200, such as by using the content provider system 102 to communicate with the content distributor system 106.

The graphical user interface 300 can include a section to present results of a first category, such as a result 302 of a content distribution campaign targeted to listed users. In some implementations, the result 302 includes results where content such as advertising was distributed to a user specified by the content provider. This may occur, for example, if the content distributor system 106 matched a keyword of the content with a topic on a publisher's page, and targeted the content presentation to one or more users that had previously contacted the content provider. The result 302 can be presented in any form, such as a graph, a table, or a list of data, to name a few examples. In some implementations, the result 302 includes a control. For example, a content provider can click on the result control to view more details of a content presentation.

The graphical user interface 300 can include a section to present results of a second category, such as a result 304 of a content distribution campaign not targeted to listed users. In some implementations, the result 304 includes results where content such as advertising was distributed to a user who was not specified by the content provider. This may occur, for example, if the content distributor system 106 matched a keyword of the content with a topic on a publisher's page, but did not target the content presentation to any users known to the content provider.

Data presented as the result 302 or 304 can be tracked by the content distributor system 106. For example, data presented can include the number of users who clicked on an advertisement, the cost of a content distribution campaign, or other metrics such as particular demographics, location, or keywords, to name just a few examples.

The results 302 and 304 can allow a content distributor to compare the results of user targeted content distribution with the results of non-user targeted content distribution. The graphical user interface 300 can include a modify content distribution control 306, such as a modify content distribution button. An advertiser can click on the modify content distribution control 306 to modify a bid for a content distribution. For example, a content provider may want to modify a content distribution campaign based on the results 302 and/or 304. In some implementations, an advertiser may be presented with other options upon clicking the modify content distribution button, such as specifying a value or values for the selected criterion, a bid amount, a start/stop date and/or time for a bid, or a budget, to name just a few examples.

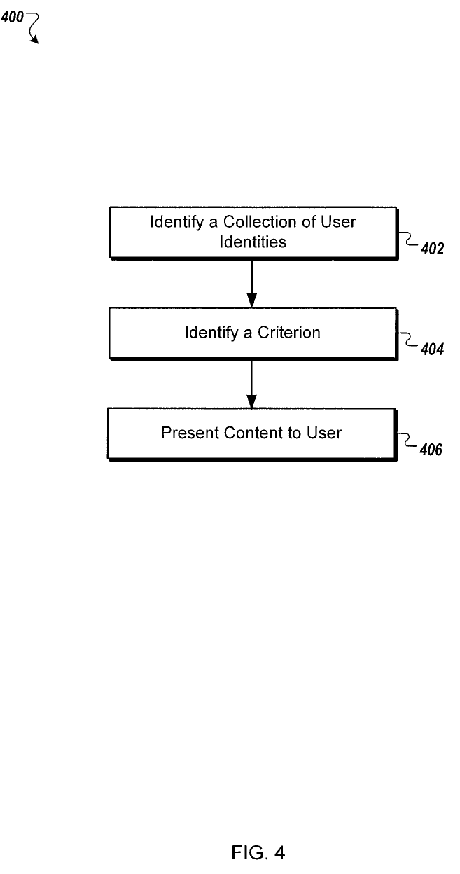

FIG. 4 is a flow chart showing an example procedure 400 for content distribution. The process 400 can be performed by a processor executing instructions stored in a computer-readable medium, such as in the system 100. More or fewer steps can be performed; as another example, one or more of the steps can be performed in a different order.

In step 402, a collection of user identities is identified. For example, an advertiser may choose a user list or a combination of user lists containing identifiers of the users to whom they wish to distribute advertisements. Furthermore, the collection of user identities can be chosen by an advertiser operating the graphical user interface 200. The content distributor system 106 can identify a collection of users stored in the repository 114. In some implementations, the content distributor system 106 may identify different user identities than ones chosen by a content provider.

In step 404, a criterion is identified. For example, an advertiser may choose a criterion or multiple criteria as conditions for content distribution. The content distributor system 106 can identify a criterion based on a criterion chosen by an operator of the graphical user interface 200. In some implementations, the content distributor system 106 may identify a different criterion than one chosen by a content provider.

In step 406, content is presented to a user. In some implementations, content is presented to a user upon a determination that the user is associated with one of the user identities identified in step 402, and that a criterion identified in step 402 is met for the content distribution. In some implementations, a content distributor system 106 may distribute content from the content database 116 over a network 104 to the content publisher system 108, which then presents the data to a user system 110 over the network 104 or another network. For example, content can be presented on a website by a content publisher 108.

In some implementations, the content distributor system 106 can choose other user identities and/or criterion to determine the users to whom content will be presented. In some implementations, the content distributor system 106 determines if a user system 110 receives content based on a hierarchy of distribution characteristics. For example, the collection of user identities and/or criterion can be influenced by the user identities chosen by a content provider. In some implementations, the content distributor system 106 may choose a criterion or modify criterion parameters to maximize or minimize click-through or presentations of content to users, to name a few examples. In some implementations, the content publisher system can opt out of presenting content to a user. For example, a company website may not wish to present an advertisement of a competitor, and may identify particular keywords that may not be used as criteria for presenting content.

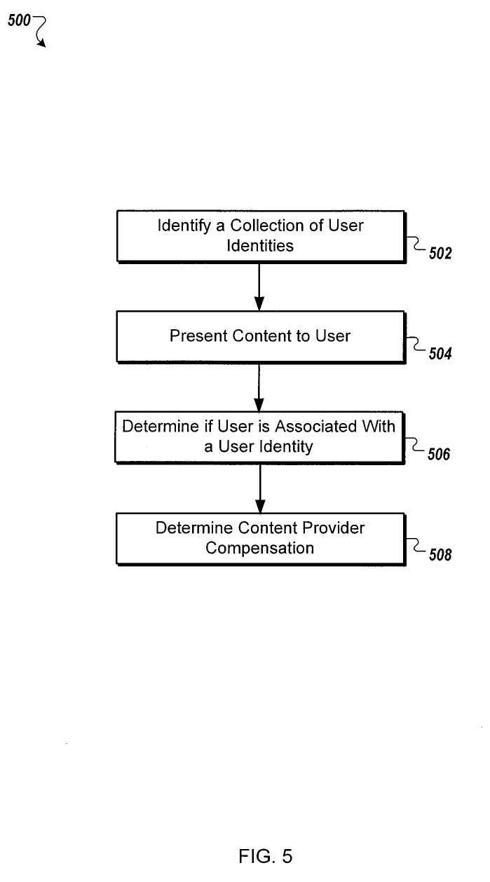

FIG. 5 is a flow chart showing an example procedure 500 for defining user-specific content distribution. The process 500 can be performed by a processor executing instructions from a computer-readable medium, such as in the system 100. More or fewer steps can be performed; as another example, one or more of the steps can be performed in a different order.

In step 502, a collection of user identities is identified. For example, a content distribution system 106 may choose a user list or a combination of user lists containing identifiers of the users to whom content will be distributed. In some implementations, the content distributor system 106 may identify different user identities than ones chosen by a content provider.

In step 504, content is presented to a user. In some implementations, a content distributor system 106 may distribute content from the content database 116 over a network 104 to the content publisher system 108, which then presents the data to a user system 110 over the network 104 or another network. For example, content can be presented on a website by a content publisher 108.

In step 506, a determination is made if a user is associated with a user identity. For example, the content publisher system 108, or the content provider system 106, may identify a user name, cookie, IP address, or other identifier or a user system 110, and the content provider system 106 may use that information to determine if a user is associated with a user identity on a user list. In some implementations, a user may be associated with multiple user identifiers and/or criterion.

In step 508, content provider compensation is determined. In some implementations, the content distributor system 106 can track metrics relating to presentation of content. For example, the content distributor system 106 can track how many users have an advertisement presented to them, how many click on a particular advertisement, how many complete a purchase after viewing an advertisement, or another metric. In another example, the users that meet a certain criterion or combination of criteria can be tracked. In some implementations, the compensation can be based on a metric tracked by the content distributor system 106. In some implementations, the compensation can be based on the user collection, a criterion, and/or a combination of either with which the user is associated. In some implementations, compensation can be based on a bid a user previously placed, such as a bid placed using the modify bid control 210, 214 or the modify content distribution control 306, to name just a few examples. In some implementations, compensation can be based on whether a criterion is optional or mandatory.

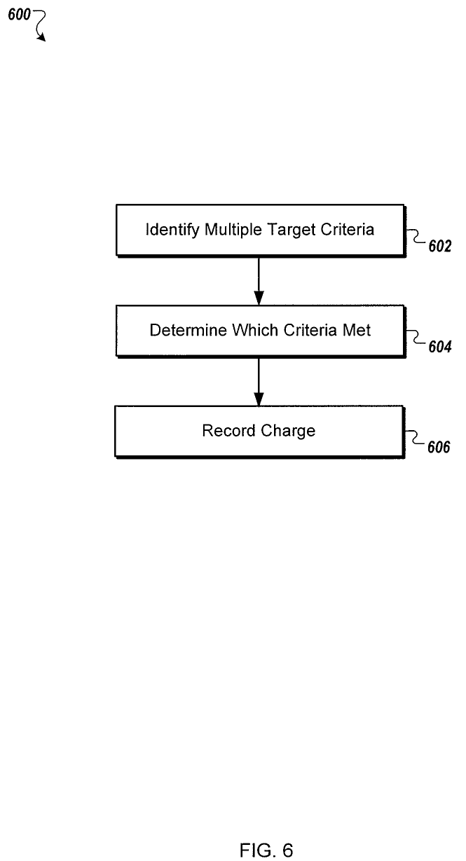

FIG. 6 is a flow chart showing an example procedure 600 for defining user-specific content distribution. The process 600 can be performed by a processor executing instructions from a computer-readable medium, such as in the system 100. More or fewer steps can be performed; as another example, one or more of the steps can be performed in a different order.

In step 602, multiple target criteria that a content provider specifies for distribution of content are identified. The multiple target criteria are associated in a hierarchy. For example, an advertiser can use the GUI 200 to define target criteria such as keywords, placements and/or user lists.

In step 604, it is determined for a presentation of the content to a user which of the multiple target criteria are met by the presentation. For example, it can be determined that an ad is presented on a particular site to a user who is on a predefined user list.

In step 606, a charge to the content provider for the presentation is recorded. The charge is determined using the hierarchy and charge values associated with the multiple target criteria. In some implementations, the advertiser can specify respective bid values for keyword, placement and user list criteria. For example, if the placement and user list criteria are met, but not the keyword criterion, the bid amount for the user list can be used as it is more specific than the placement criterion.

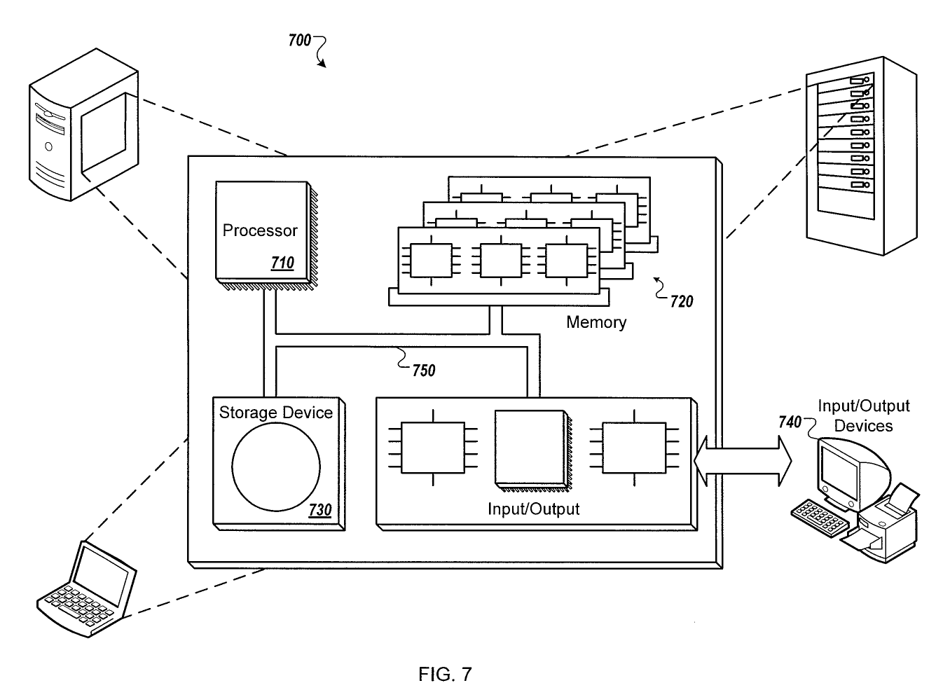

FIG. 7 is a schematic diagram of a generic computer system 700. The system 700 can be used for the operations described in association with any of the computer-implement methods described previously, according to one implementation. The system 700 includes a processor 710, a memory 720, a storage device 730, and an input/output device 740. The components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer program product tangibly embodied in a computer-readable storage medium and comprising instructions that when executed by a processor perform a method of determining charge for content presentation, the method comprising:
identifying multiple target criteria that a content provider specifies for distribution of content, the multiple target criteria associated in a hierarchy;
determining, for a presentation of the content to a user, which of the multiple target criteria are met by the presentation; and
recording a charge to the content provider for the presentation, the charge determined using the hierarchy and charge values associated with the multiple target criteria.

2. The computer program product of claim 1, the method further comprising determining, before the content is presented, whether a publisher that is to publish the content in the content distribution has opted out of user-targeted content distribution.

3. The computer program product of claim 1, wherein the multiple target criteria comprise at least: a first target criterion that the content be presented to a user associated with at least one of a collection of user identifiers; a second target criterion that the content be presented in a predetermined resource; and a third target criterion that the content be presented in association with a predetermined keyword.

4. The computer program product of claim 3, wherein at least two of the multiple target criteria are met by the presentation, further comprising selecting one of the at least two target criteria and using the one target criterion in determining the charge.

5. The computer program product of claim 4, wherein the multiple target criteria are ranked according to specificity in the hierarchy, and wherein the one target criterion is selected as being most specific of the at least two target criteria met by the presentation.

6. The computer program product of claim 3, wherein another collection of user identities is identified by the content provider, and wherein the other collection of user identities also is taken into account in the determination.

7. The computer program product of claim 6, the method further comprising forming a logical combination collection based on the collection of user identities and the other collection of user identities, wherein the logical combination collection is taken into account in the determination.

8. The computer program product of claim 3, the method further comprising performing an evaluation of a duration or expiration measure for the collection of user identities, wherein the evaluation is taken into account in the determination.

9. The computer program product of claim 3, wherein the content provider has submitted a bid for the content distribution comprising at least two different bid amounts, wherein the charge values are based on the different bid amounts, and wherein at least one of the different bid amounts is conditioned on the determination that the user is associated with one of the user identities.

10. The computer program product of claim 1, wherein the multiple target criteria includes at least one selected from the group consisting of:
a user action;
a user access of a specific resource;
a demographic criterion;
a keyword for matching against a publication where the content distribution is made;
an identifier for the publication where the content distribution is made;
a language of the publication where the content distribution is made;
a geographic location of the user;
a time of day when the content distribution is made;
a location in the publication where the content distribution is made;
a metric regarding the publication where the content distribution is made;
a maximum number of presentations associated with the content.

11. A computer program product tangibly embodied in a computer-readable storage medium, the computer program product including instructions that, when executed, generate on a display device a graphical user interface for defining user-specific content presentation, the graphical user interface comprising:
at least one criterion input control for a content provider to specify multiple target criteria associated in a hierarchy, the multiple target criteria configured for use in selecting between a plurality of users for receiving a content distribution; and
a charge input control for the content provider to define respective charge values associated with the multiple target criteria, wherein a charge to the content provider is recorded for a presentation of the content to a user, the charge determined using the hierarchy and the charge value associated with any of the multiple target criteria met by the presentation.

12. The computer program product of claim 11, wherein the criterion input control is configured for use by the content provider in uploading a collection of user identities.

13. The computer program product of claim 12 wherein the criterion input control is configured so that the content provider can offer the collection of user identities for use by another content provider.

14. The computer program product of claim 11, wherein the multiple target criteria comprise at least: a first target criterion that the content be presented to a user associated with at least one of a collection of user identifiers; a second target criterion that the content be presented in a predetermined resource; and a third target criterion that the content be presented in association with a predetermined keyword.

15. The computer program product of claim 11, wherein at least two of the multiple target criteria are met by the presentation, and wherein one of the at least two target criteria is selected and used in determining the charge.

16. The computer program product of claim 15, wherein the multiple target criteria are ranked according to specificity in the hierarchy, and wherein the one target criterion is selected as being most specific of the at least two target criteria met by the presentation.

17. The computer program product of claim 11, wherein the graphical user interface further comprises a performance reporting area presenting a result of the content distribution to the content provider.

18. The computer program product of claim 17, wherein the performance reporting area divides the result in at least first and second result categories:
the first result category corresponding to a portion of the content distribution performed to at least a first user who is not associated with a collection of user identities specified by the content provider as one of the multiple target criteria; and
the second category corresponding to a portion of the content distribution performed to at least a second user who is associated with one of the user identities.
